(19) United States
(12) Patent Application Publication
(10) Pub. No.: US 2020/0027147 A1
(43) Pub. Date: Jan. 23, 2020

(54) HEAT TRANSFER BONDING SYSTEM AND METHOD OF USE

(71) Applicant: Avery Dennison Retail Information Services, LLC, Mentor, OH (US)

(72) Inventors: Tyler Dahlstrom, Visalia, CA (US); Yael Rosenblum, Allston, MA (US)

(21) Appl. No.: 16/519,682

(22) Filed: Jul. 23, 2019

Related U.S. Application Data
(60) Provisional application No. 62/701,946, filed on Jul. 23, 2018.

(51) Int. Cl. G06Q 30/06; G06Q 20/18; G06F 3/0482; G06Q 20/32; H04N 1/00; H04N 1/54; B44C 1/17

(52) U.S. Cl. CPC G06Q 30/0621; G06Q 20/18; G06Q 30/0643; B44C 1/1712; G06Q 20/3278; H04N 1/0019; H04N 1/54; G06F 3/0482

(57) ABSTRACT

A heat transfer bonding system and method of use in which heat transfers may be prepared using an interface, printed using a printer in a manner that preserves the spacing that the heat transfer is intended to have on an article to which it will be applied, and applied using a bonding system such as an automated heat press. Various aspects of the heat transfer, such as color, may be customized via the interface. Such a system may allow for the rapid application of customized heat transfers to garments in a manner that allows garment customization systems to be deployed to retail stores such that customers can prepare a customized garment while they wait.

### CROSS REFERENCE TO RELATED APPLICATION

The present application claims priority from U.S. Provisional Application No. 62/701,946 filed Jul. 23, 2018, which is incorporated by herein by reference in its entirety.

### FIELD OF THE INVENTION

The present application relates generally to heat bonding systems and methods of use.

### BACKGROUND OF THE INVENTION

“Heat printing” or “heat transfer printing” is a process by which heat-applied materials, most commonly labels, may be applied to various articles or substrates. Heat-applied materials contain a heat-sensitive adhesive on one side, which may be positioned so that it faces the substrate. The substrate, with the heat-applied material, may then be placed into a heat press, which will uniformly apply heat to the heat-applied material and the substrate. This will cause the heat-applied material to be permanently bonded to the substrate.

There are certain important factors that must typically be considered and balanced when applying a heat transfer. These will typically depend on the heat-applied materials and the heat press being used, as well as on the desired end result. Typically, the most important considerations are time, temperature, and pressure. “Time” means the amount of time that heat must be applied or an amount of time that heat actually is applied to the heat-applied materials or to the substrate. “Temperature” means the most optimal temperature at which the heat-applied materials will adhere to the substrate. “Pressure” means the amount of downward force that may be necessary when performing the heat application process in order to properly adhere the heat-applied materials to the substrate. Other factors such as the space that may be taken up by the heat press equipment, the desired production quantities of the heat press, the size of the garments that may be decorated, the level of experience of the heat press user, or the overall cost of the heat press or any other materials may also affect the application process.

Numerous heat press designs exist, which may each have certain benefits and drawbacks, and which may be chosen by a user based on how the user wishes to balance the aforementioned factors. The three most common heat press designs are the “auto open clam” design, the “swinger/draw” design, and the “air swinger/draw” design. The “auto open clam” design features a vertically-opening “clamshell-style” press, which requires the least amount of management, poses a low risk of burning garments, takes up very little space, and is highly portable; these are typically seen as the best option for new or low-volume users. The “swinger/draw” design features a heat press suspended over a platen by a swivel, and allows substrates to be threaded on or off of the press in a heat-free workspace. For reference, a “platen” is an interchangeable heat press component that, like the platen of a printing press, acts to press a substrate against the applied heat transfer even if the substrate has an unusual geometry. This allows for a higher volume of work to be produced, but takes up more space and is more complex to operate. The “air swinger/draw” design reduces fatigue through the use of compressed air, typically being more expensive than the “swinger-draw” design, but more efficient in a high-volume environment.

The most common application of the heat transfer process is in decorating garments, particularly custom garments. Many companies offer services that allow users to choose from one of a selection of custom labels to be applied to a blank garment, allowing users to design their own corporate T-shirts, sports jerseys, and the like. The heat transfer process provides a method by which small numbers of garments (potentially even only one custom garment) can be prepared to have labeling in a manner that is quick, permanent, and that does not involve messy inks or expensive screens.

Certain problems exist with the heat transfer printing process as it currently stands. A major problem has to do with preparation time. When preparing a heat transfer, for example, a user must choose a desired image or pattern, prepare it on transfer paper (for example, using a standard inkjet or laser printer to print the pattern), and then, once the image or pattern has been prepared, carefully remove all extraneous material by cutting it away (“weeding”). When a large number of identical pattern cuts are desired, an industrial cutting process can typically be used. However, when a small number of pattern cuts are desired, or just one image or pattern is to be cut out, it is not economical to make use of an industrial process and cutting must be done manually. As such, heat transfers are typically produced in the form of stock items, such as common names, numbers, common logos or crests, individual letters or symbols, and so forth. Multiple transfers can then be combined in order to embellish a single garment. For example, an intramural sports activity may provide T-shirts to all its participants, which may have a set of team numbers and a team logo provided on the front side of the shirt, and a set of team numbers and a participant name provided on the back side of the shirt. Each of these may require a separate heat transfer, resulting in at least six being used in most cases.

Positioning and aligning a multiplicity of heat transfers consistently can be extremely challenging and time-consuming, however, and may lead to a loss of customer satisfaction if not done correctly. For example, if a batch of T-shirts intended for a team or for an organization are mismatched or have different features in different places, the T-shirts may look visibly different, reflecting poorly on the printing company. This may also have detrimental effects for the organization as the intended goal of promoting uniformity and camaraderie may not be met if some wearers feel slighted for getting the “defective” shirts.

The existing workarounds for these and other deficiencies that exist in the heat transfer printing field are not adequate to address the problem. A user that wishes to make use of a custom arrangement of stock transfers must wait a long time, and a user that needs a custom heat transfer in order to ensure that all of the logo information, name information, and so forth are already pre-positioned in the correct places must wait longer still. A custom heat transfer will usually have to be designed, ordered, and mailed to the customer before they can have it printed, though in some cases users will have the ability to make and print their own. Since neither a custom arrangement of stock transfers or a custom transfer can be prepared quickly, it is typically not possible for the user to have a garment or set of garments printed for them in a short span of time during the customer's visit to a store.

The best current solution is for technicians to spend an extensive amount of time measuring, using rulers and plastic templates, the precise positions of each individual stock heat transfer item to be printed as part of the single, larger embellishment, such that stock materials can be used but such that they are unlikely to be placed incorrectly. This ensures that the embellishment can be applied to the garment using just the stock heat transfer items without the use of a custom heat transfer. This method has obvious downsides, as it usually takes a significant amount of time for a skilled or semi-skilled technician to make this happen. As a result, the process is costlier. For example, in one case, it took around fifteen minutes for the entire preparation process to be completed, wherein a customer chose a garment off of the shelf, selected options to customize the garment with stock heat transfer items, had a technician collect the required material inventory, had a technician use rulers and plastic templates to line up and position all of the numbers and letters to be applied to the garment, and begin the heat press.

### BRIEF SUMMARY OF THE INVENTION

A heat transfer bonding system for performing a faster and more streamlined process for heat transfer bonding is contemplated. Such a process may combine a direct-to-garment design and production interface with an automated bonder or other heat press with a vision system for heat-bonded material placement, allowing for garments to be rapidly customized using multiple transfers at once. The vision system integrates the digital workflow and design files with a webshop front-end, or other similar interface, to display the intended layout and parameters onto a garment/article.

According to some embodiments, a heat transfer bonding system comprises an interface component, a digital workflow having an ordering interface, a bonder configured to initiate a bonding process, and a vision system. In some embodiments, the interface component is a touch screen. In some embodiments, one or more letter and/or number combinations are preloaded on the interface component. According to some embodiments, the bonder is automated. In some embodiments, the interface component is configured to allow a user upload a heat transfer pattern. In some embodiments, the interface component may be further configured to interpret the heat transfer pattern and map the heat transfer pattern to an interface heat transfer pattern specific to an article. According to some embodiments, the interface component is configured to allow a user to input information on a specific article in order to upload article identity information to the ordering interface. In some embodiments, the interface component is configured to allow a user to scan a label on the specific article in order to upload the article identity information. According to some embodiments, the heat transfer bonding system further comprises a self-service kiosk.

According to some embodiments of the present disclosure, a method for ordering a customized article comprises accessing an interface, selecting an article, selecting one or more heat transfer items, arranging the one or more heat transfer items on the article, and finalizing an order. In some embodiments, more than one article may be selected. Thus in some embodiments, the one or more heat transfer items may be arranged on any one or more, or each, of the selected articles. In some embodiments, a method for ordering a customized article further comprises uploading a heat transfer pattern into the interface. In such embodiments, the method may further comprise interpreting, by the interface, the heat transfer pattern, and mapping, by the interface, the heat transfer pattern to an interface heat transfer pattern specific to the article.

In some embodiments, the method for ordering a customized article further comprises scanning an RFID tag of an article at an RFID scanner at a self-service kiosk. In such embodiments, the method may further comprise determining, by the self-service kiosk, whether the article is one that exists in a database associated with the interface. In some embodiments, if the garment is not identified in the database associated with the interface, the self-service kiosk retrieves information about the garment. In some embodiments, information about the garment comprises attribute information stored in the RFID tag or attribute information available from an online database. In some embodiments, the interface is a web interface. In some embodiments, the interface is a mobile device application.

According to other embodiments of the present disclosure, a method for preparing a customized article comprises receiving an order in a production database for an article to be customized with a heat transfer, preparing at least one heat transfer sheet based on the order received in the production database, selecting one or more platens to support the article, bonding, via an automated bonder, the at least one heat transfer sheet to the article. In some embodiments, the method for preparing a customized article further comprises projecting an image of the heat transfer onto the article before bonding the step of bonding. In some embodiments, the method further comprises shipping the article to a customer. And in some embodiments, the method further comprises performing quality control of customized articles after the step of bonding.

The overall effect of the systems and methods contemplated herein may be to provide rapid customization of a garment or article by using multiple heat transfers at once, including one or more individual letters, names, numbers, and logos, or any combination of the foregoing, each in any arrangement or style (e.g., font, size, etc.), or the application of trim or other embellishments. By eliminating the difficulties in lining up heat transfers, the embodiments described herein may save at least two to four minutes per garment or article, thus significantly reducing production times and costs.

According to some embodiments, the system may be usable in one or both of a factory or a retail setting, or conceivably in other settings. For example, a large organization (such as a college or university) may operate one or more embodiments of the system disclosed herein to prepare garments or other articles for intra-organizational groups or other purposes like community events.

According to some embodiments, the system is configured to work with a variety of platens, in many different sizes, shapes, and types (such as for different garment types), which may be enabled with vision system controls and/or automated robotics-integrated technology. As noted herein, in some embodiments, some or all of these platens may be configured to be “threaded” platens, and may be configured so that the platens can be rapidly inserted into or removed from a garment.

### BRIEF DESCRIPTION OF THE DRAWINGS

Advantages of embodiments of the present invention will be apparent from the following detailed description of the exemplary embodiments thereof, which description should be considered in conjunction with the accompanying drawings in which like numerals indicate like elements, and in which:

FIG. 1 is an exemplary embodiment of a process for preparing and performing heat transfer bonding;

FIG. 2 is an exemplary embodiment of a clothing selection interface that may be provided along with a system for preparing and performing heat transfer bonding;

FIG. 3 is an exemplary embodiment of a heat transfer design interface that may be provided along with a system for preparing and performing heat transfer bonding;

FIG. 4 is an exemplary embodiment of a heat transfer design interface that may be provided along with a system for preparing and performing heat transfer bonding;

FIG. 5 is an exemplary embodiment of a heat transfer design interface that may be provided along with a system for preparing and performing heat transfer bonding;

FIG. 6 is a pictorial diagram depicting an exemplary embodiment of a process for preparing and bonding a heat transfer; and

FIG. 7 is an exemplary embodiment of a completed heat transfer.

### DETAILED DESCRIPTION OF THE INVENTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

According to an exemplary embodiment, and referring generally to the Figures, various exemplary implementations of a heat transfer bonding system and method of use may be disclosed.

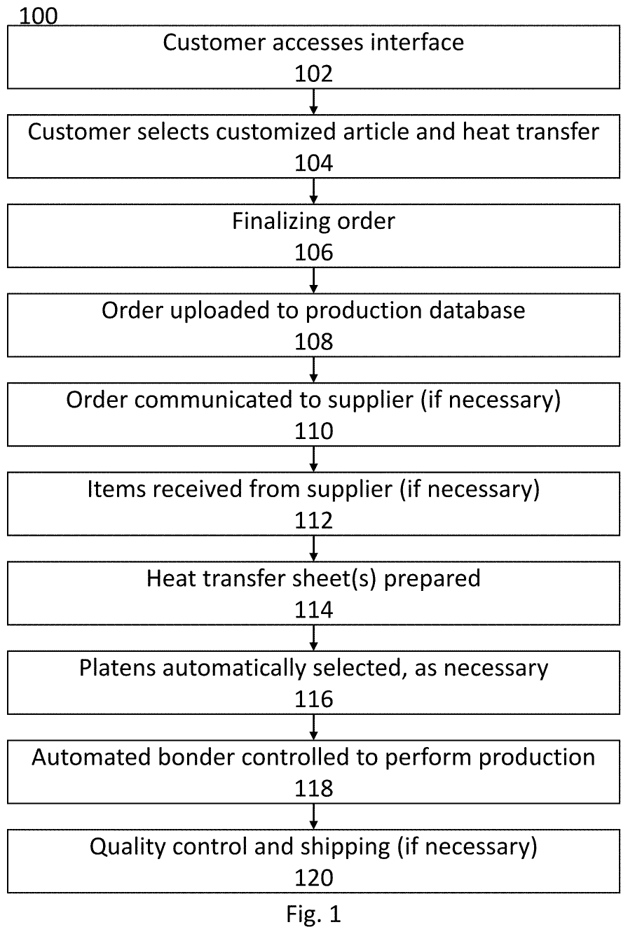

Turning now to exemplary FIG. 1, FIG. 1 displays an exemplary embodiment of a process for preparing and performing heat transfer bonding 100. According to some embodiments, a customer may access an interface at step 102, by which the customer can prepare a heat transfer to be applied to a garment. In certain exemplary embodiments, such an interface may be provided on a customer's home workstation. For example, a Web interface may be provided by which a user or customer can prepare a heat transfer. Additionally, or alternatively, a program may be provided to a user or customer (such as a mobile device application) by which the user or customer can prepare a heat transfer. In some embodiments, such an interface may be provided at a brick-and-mortar store location, such as in the form of a self-service kiosk or as provided by another computer such as may be desired.

In a next step, once the customer has accessed the interface 102, the customer may be able to select one or more certain articles to be customized and one or more certain heat transfers to be applied to each of the one or more articles 104. In some embodiments, a customer has the option to select from certain specific articles, such as certain specific articles of clothing that may be stocked by a particular retail chain. In other embodiments, a customer is provided with the option to broadly select from certain types of articles. For example, the customer may be provided with the option to select from short sleeve shirts, long sleeve shirts, hats, and so forth, and may then be provided with the option to select a size, and optionally to select from women's or men's sizes, once the customer has made his or her selection. Users may also select a color of the article, may select any predefined labeling or branding to be applied to the article, or may customize any other aspects of the article such as may be desired. For example, a sports fan may wish to apply certain fan-made customizations to a team jersey, and may be able to specify team colors for a blank jersey or may be able to further modify an off-the-rack team jersey, such as may be desired.

Other variants may also be contemplated. For example, in some exemplary embodiments, certain articles not carried by a particular retail chain or particular vendor, but which may be available from another vendor, may be shown and provided to the customer, optionally along with an ordering fee. For example, a blank team jersey in certain colors may not be available or in-stock at a certain brick-and-mortar retail store, but may be available from a third-party vendor for purchase. Thus in some embodiments, the user may be able to order both articles that are stocked by the vendor and articles that are not stocked by the vendor, both through the same interface, after designing a heat transfer to be applied to either or both. In some exemplary embodiments, articles may then be sent to the brick-and-mortar store or may be sent directly to the customer, such as may be desired.

In some exemplary embodiments, users may want to further customize a pre-existing article, such as an article they already own or an article that they have purchased from elsewhere. As such, in some exemplary embodiments, a user may be able to select a customized article on the interface that corresponds to the one that they already own or have purchased elsewhere, or a similar customized article to the one that they already own or have purchased elsewhere. In some exemplary embodiments, users may also be able to input or scan label information from an existing article in order to upload this information. For example, customers may be able to scan an RFID tag of a garment at an RFID scanner in a self-service kiosk, which may identify the user's garment to the kiosk. The kiosk may then determine whether the garment is one that exists in a database associated with the interface. If the garment is not in a database associated with the interface, the kiosk may retrieve information about the garment, such as attribute information stored in the RFID tag or attribute information available from an online database or the internet. The kiosk may then bring up the customer's garment or as close a match as possible to the customer's garment on the interface. Similarly mentioned above, the user may then order said garment by a vendor if found in the online database or internet.

In some exemplary embodiments, users may customize the attributes of a garment or other article from a predefined, default option in the interface. For example, a user may be able to specify the measurements (or any other attributes such as color, material composition, and so forth) of a shirt on the interface in order to ensure that the interface's representation of a shirt has the same attributes as the shirt that they may have purchased elsewhere. This may provide the user with a manual option for inputting data describing their article, allowing the user to describe (and generate customized heat transfers for) any article. In addition to being able to customize the attributes of a garment or other article, a user may save their creation within a database or within a cloud storage platform. The saved creation may be revisited for additional customization, revision, or future ordering. In some embodiments, the cloud storage platform may also be used as the main location for information and attribute storage. The database and/or cloud may be associated with the interface.

Still at step 104, once the customer has selected one or more articles to be customized, they may then select one or more heat transfers to apply to each of the one or more articles. According to some embodiments, customers may select from a variety of predefined letters, numbers, shapes, symbols, images, and so forth to be added to a heat transfer, which may allow a customer to quickly define individual letters, numbers, shapes, symbols, images, etc., in any arrangement or style, or allow the customer to define one or more names, numbers, logos, combinations of the foregoing, or any other heat transfer patterns. According to some exemplary embodiments, predefined patterns may also be available to the user for their selection. For example, customers may select from predefined sports jersey designs featuring a name and team number of top players, or all players, in a variety of sports. Customers may also be able to customize these predefined patterns, and may for example be able to add trim or other embellishments to a letter, number, shape, etc., in order to better accentuate or define the letter, number, shape, etc.

In some exemplary embodiments, users may upload their own heat transfer pattern(s) into an interface, such as patterns that the user may have found elsewhere (e.g., online) or patterns that the user may have designed using a graphic art program. The interface may then interpret these heat transfer patterns to the greatest extent possible in order to map them to an interface heat transfer pattern specific to the garment or other article in question. In some exemplary embodiments, the user may then apply customizations to the uploaded pattern, for example, if the user wishes to change the position or orientation of the pattern on the specific article.

According to some embodiments, a user may have the option to specify one or more colors for the heat transfer, or specify one or more attributes. For example, in some exemplary embodiments, one-color and two-color (or multiple-color) heat transfer designs are contemplated, and may each be available for the user to select. Different materials may also be available to the user, such as vinyl or PVC heat transfers, silicone heat transfers, tags with fabric, embroidered materials, or any other materials contemplated for use in a heat transfer press.

In some exemplary embodiments, however, it may be desired to restrict the user's selection by what is available. This may be most applicable in situations in which the customer wants to visit a brick-and-mortar store and have a heat transfer printed in person. For example, it may be understood that many heat transfer materials, such as vinyl, have multiple options for how they can be prepared. Vinyl heat transfers, for example, are most often prepared using a 1-color design, or a 2-color design. A 1-color design is one in which no ink is printed on the vinyl, so the vinyl is all just one color. Instead, cavities are cut out of the vinyl so that the original color of the garment or other article can be seen through the vinyl, with the color of the vinyl and the color of the garment both being used to complete the design. For example, when a white vinyl heat transfer is placed on a black T-shirt, a shape that is intended to be shown as black may be cut out of the vinyl transfer so that the fabric of the T-shirt shows through the vinyl. A 2-color design (or multiple-color design) will typically be one in which an ink printer has been used to apply a design to the surface of the vinyl, providing additional color options. A 2-color design (or multiple-color design) may be prepared depending on the material stocks and the equipment available at a brick-and-mortar location. For example, it may be possible for a heat press operator in a retail store to prepare 1-color designs, but it may not be possible for them to prepare 2-color designs due to lack of equipment. Color options may likewise be limited and may be restricted based on availability. Thus in some embodiments, an interface, such as a web interface or a kiosk interface, may restrict the user to choosing only options that reflect materials in stock or equipment available at a selected location. In some exemplary embodiments, a web interface may connect to inventory management systems at a selected location to verify which materials are in stock and/or which equipment is available. In some embodiments, certain options may be indicated as being fulfill-able immediately in-store, and other options may be indicated as being fulfill-able sometime after ordering (such as after the necessary inventory has been shipped to the retail store). In some embodiments, the interface may direct a customer to a different brick-and-mortar location that has the necessary materials in stock and/or available equipment to customize the heat transfer according to the customer's specifications. In some embodiments, the customer may specify a given distance (e.g., geographical area or region) within which the customer is willing to travel to obtain the customized article and heat transfer.

In some embodiments, once the user has defined a garment or other article onto which the heat transfer is to be applied, and has defined a heat transfer to be applied, the user may then be able to select a position on the garment or other article on which the heat transfer is to be applied. Alternatively, the user may specify where on the article one specific element of the heat transfer is to be applied, after which the heat transfer to be printed may be updated accordingly in order to take into account the user's placement. In an exemplary embodiment, the system may calculate an optimal placement of the heat transfer elements such that as few sheets need to be printed as possible, while still preserving the relative spacing of the heat transfer elements on the heat transfers. For example, in most cases, up to three sheets be printed: one sheet corresponding to one or more heat transfers to be placed on the front of the article, such as on the front of a shirt; one sheet corresponding to one or more heat transfers to be placed on either or both sides of the article such, as on one or both of the sleeves of a shirt; and one sheet corresponding to one or more heat transfers to be placed on the back of an article, such as on the back of a shirt. If a user specifies front, back, and side elements, these may automatically be mapped to the sheets in question.

Other arrangements may also be contemplated. For example, in some exemplary embodiments, users may define certain relations between heat transfer elements, such as spacing between heat transfer elements, rather than defining the heat transfer elements based on their placement on an article or garment. For example, a user may be able to define a heat transfer element as having a player name or team name provided exactly a certain distance from a player number. The system may then be able to prepare a sheet having this defined relation.

Once the customer has selected one or more articles and one or more heat transfers to be applied to each of the one or more articles in step 104, the customer may finalize their order at 106. In some exemplary embodiments, order finalization may include, providing customer information or payment information. Information that may be required to finalize an order on an interface may depend on where the interface is located. For example, in some exemplary embodiments, an interface provided on a kiosk may be integrated with a point-of-sale system and the customer may be charged through that point-of-sale system. In some embodiments, a Web interface may provide an option for the user to pay by credit card or by an online payment service, after which the order may be transmitted. In some embodiments, an interface provided by a downloaded program may allow the user to submit the design online using an Internet connection, paying for the order by credit card or an online payment service, or the interface may allow a user to generate a file that they can then take to a brick-and-mortar location, paying for the order at that location. The user may also specify customer information. For example, the user may specify shipping address information if the article is intended to be shipped to the user or any other desired location, or if the user has ordered an article from a third-party vendor and wishes to take it into a brick-and-mortar location in order to have a heat transfer process be completed for that article. Other finalization steps may also be performed such as may be desired or necessary.

In a next step, the customer's order may be uploaded to a production database at 108, for example, from a Web interface, from an external program (such as a mobile application), or from any other source. In some embodiments, if it is necessary to request additional inventory (such as if the customer has ordered an item that is not in stock, or if the user has ordered an item from a third-party vendor), an order may be communicated to the relevant supplier at 110. For example, an order may be communicated to a supplier in a supply chain of a retail store or a third-party vendor. Once any missing or out of stock items have been received from the supplier at 112, the process 100 may continue.

In a next step, the heat transfer, which may comprise one or more heat transfer sheets, may be prepared at 114. The heat transfer may be prepared by printing or through any other acceptable method for preparing a heat transfer sheet as will be known and appreciated by those of ordinary skill in the art.

In a next step, the platen or platens to be used during a printing process, or during certain stages of a printing process, may be identified and selected at 116. For example, according to embodiments in which a heat transfer is to be applied to a hat, a platen may constitute a support frame or stand for the hat, and the system may indicate that such a platen is necessary and may provide instructions for proper use and placement of the hat on the platen. In other embodiments, such as when a heat transfer will be provided on a T-shirt or other such article of clothing that can be laid flat and which does not require support, the system may not determine that the use of any specific platen(s) is necessary, and thus may not select any specific platen(s) in an automatic selection stage at 116.

In certain exemplary embodiments, such a process may be applied to an industrial process, with customer orders being large bulk orders rather than one-off orders or small, limited orders. Thus it may be desired to have an automated bonder to consistently produce a high volume of the same garment. In such embodiments, the same platen(s) may be used to produce each garment and thus selection of the platen(s) at 116 may be relatively simple. In other embodiments, however, the operator of an automated bonder may instead desire to rapidly produce unique items, such as one-off customer orders or personalized items for members of a group, which may each require different platens. In such embodiments, an automated bonder may be configured to automatically change platens or may be configured to otherwise facilitate quick platen change.

In a next step, once platens have been selected, an automated bonder may be controlled to perform production of the article(s) or garment(s) by applying the heat transfer at 118. In some exemplary embodiments, intermediate manual intervention may be necessary, such as between articles or even during production of a particular article. For example, if it is desired to heat press a heat transfer to the front and back of a T-shirt during one production step and then heat press a heat transfer to the sleeves of a T-shirt during a next production step, manual intervention may be required.

After the heat transfer has been applied to the article or garment, any subsequent steps, such as a quality control and/or shipping, may be performed at 120. Performance of any subsequent steps may, for example, depend on the production environment in which the articles are prepared. In some embodiments, where articles having heat transfer embellishments are produced on a factory production line for later shipping, quality control and shipping may be necessary. In other embodiments, where articles having heat transfer embellishments are to be produced one at a time in a brick-and-mortar retail store, such as in the fabric department of a craft store, no specific quality control or shipping steps may be necessary.

In some exemplary embodiments, certain steps may be added or removed, or certain steps may be rearranged or otherwise varied. For example, some embodiments of the process may be used by local retailers to produce a stock of pre-printed articles for sale under circumstances where it might not be economical to prepare large stocks of those articles for distribution on a regional or nationwide level, or where it might not be economical to sell those articles outside of that store. For example, a gift shop may have souvenir T-shirts that rotate on a seasonal basis, or a department store may stock fan apparel for a local minor league team. Under such circumstances, no packing and shipping step may be necessary, and the apparel or other articles to which the heat transfers are applied may simply be added to inventory. In such embodiments, the payment step may also be rearranged so that payment is provided at the end of the process rather than after the customer has placed a custom order. A person of skill in the art will appreciate that in other exemplary embodiments, other steps may be removed, added, or interchanged or otherwise varied as may be desired.

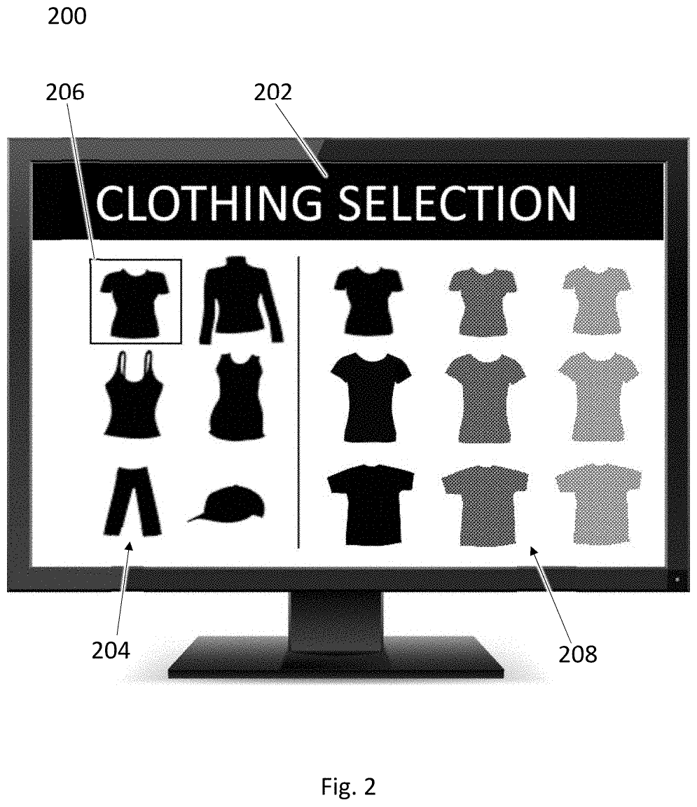

Turning next to exemplary FIG. 2, FIG. 2 shows an exemplary embodiment of a clothing selection interface 200. According to some embodiments, upon accessing a clothing selection interface 200, a user may make one or more clothing selections 202, which may be shown in a first portion of the interface. For example, a user may be able to select from clothing categories 204 including short-sleeve shirts, long-sleeve shirts, camisoles, sleeveless shirts, tops, dresses, pants, shorts, hats, and any other clothing or other articles. As shown in FIG. 2, a user may select from various categories of women's clothing. In some embodiments, a user may be provided with an option to specify the clothing category, or may be provided with an option to switch between clothing categories. Other clothing categories may also be understood and provided for user selection. For example, a user may switch between seasonal clothing, such as summer and winter clothing, or clothing based on function, such as active wear versus non-sportswear clothing items.

Once the user has selected a specific category of clothing, as shown at 206, the selected category of clothing may be highlighted and certain clothing options 208 within the selected category 206 may be provided for that category of clothing. For example, a user may be able to select from certain variations on style, color, size, material composition, and any other variations.

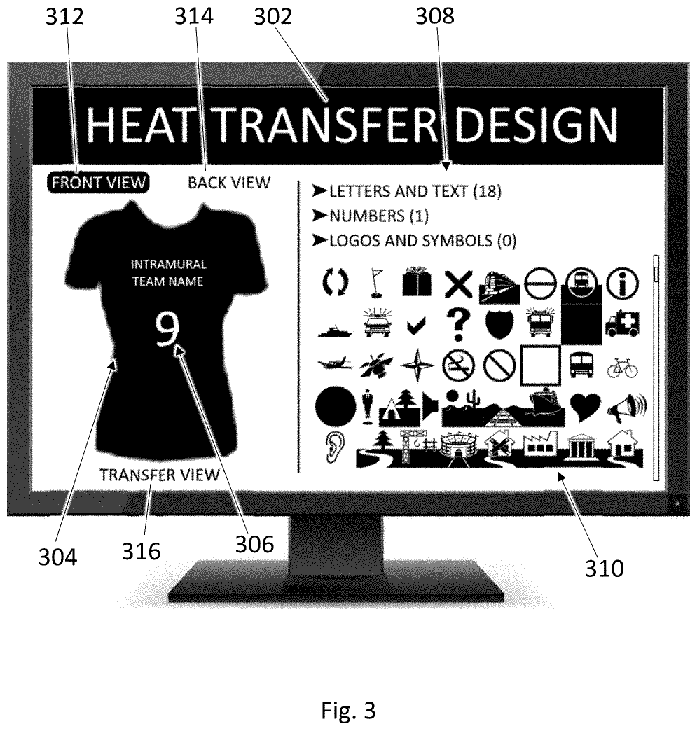

Turning next to exemplary FIG. 3, once the user has selected a specific clothing option, the user may be directed to a heat transfer design interface 302, which may prompt the user to select and arrange a heat transfer design. According to some embodiments, heat transfer design interface 302 provides the user may with a visualization of their selected article of clothing 304, along with a visualization of the heat transfer embellishment 306 as applied to the selected article of clothing 304. According to some embodiments, the user may select from multiple different types of heat transfers to be applied, as shown at 308, such as letters or groups of letters (names or other text), numbers, logos, symbols, etc. Heat transfer design interface 300 may provide a visualization of the available types of heat transfers to be applied, as shown at 310. In certain exemplary embodiments, a user may adjust one or more attributes of these heat transfers such as size, color, font, style (e.g., bold, underlined, or italicized with respect to letters and numbers), etc., upon placement. In some exemplary embodiments, users may also be able to select what type of heat transfer should be applied (e.g., 1-color, 2-color, or multi-color) or other aspects such as trim or other embellishments to be applied. In some embodiments, a heat transfer design interface 302 may also include preset combinations of letters, numbers, logos, and the like, such as a preset combination that duplicates the appearance of a particular player's jersey and which causes that player's name and number to be spelled out (for example, on the back of a garment), automatically adding those letters and numbers to the heat transfer. Other such combinations are possible.

In some embodiments, a heat transfer design interface 302 may provide a user with a plurality of options that they can use in order to better view the placement of their heat transfer(s) on a garment or other article. For example, heat transfer design interface 300 may provide the user with a front view 312, a back view 314, and a view of the transfer or transfers that will be printed 316. In some embodiments, additional options may be provided, such as an option to return to a clothing selection interface 200, an option to rotate a three-dimensional view of the garment, or any other option.

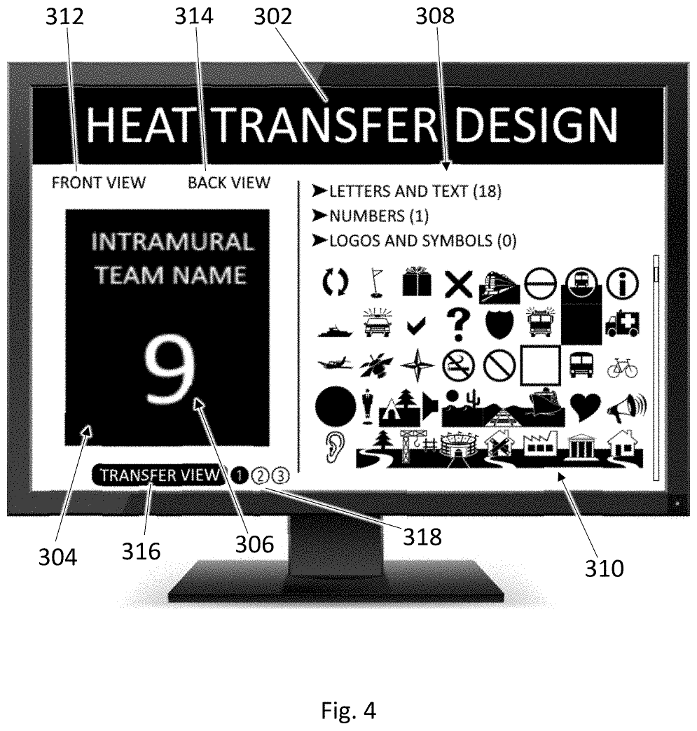

Turning now to exemplary FIG. 4, an exemplary embodiment of a heat transfer design interface 302 showing a transfer view screen 316 is shown. According to some embodiments, an arrangement of heat transfer elements may be shown (in this case as white on a black background, but in any other fashion as desired), with the heat transfer elements having the same relative spacing as they will have as part of the heat transfer embellishment on the garment. In some embodiments, a heat transfer element preview may be shown mirrored, to reflect how it may be printed. In some embodiments, multiple heat transfers may be needed to capture all arrangements of heat transfer elements to be provided on the garment. As such, multiple heat transfer views may be selectable, as shown at 318, in the heat transfer design interface 302.

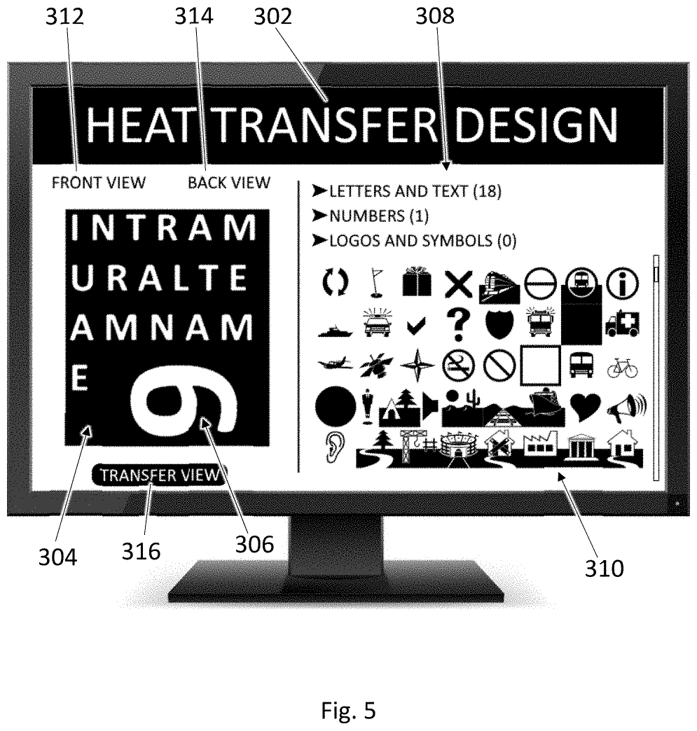

Turning now to exemplary FIG. 5, another exemplary embodiment of a heat transfer design interface 302 showing a transfer view screen 316 is illustrated. In certain embodiments, a customer may determine that material cost is of more concern than the precise or exact arrangement of their heat transfers. In such embodiments, a user may select an option to revert a heat transfer design to a non-spaced design, as illustrated. While a non-spaced design advantageously may conserve materials, it may make it more difficult to apply the heat transfer material in a precise arrangement and may thus raise the potential for mistakes. In certain exemplary embodiments, a user may freely switch between the two options (e.g., spaced or non-spaced) before making a final selection for printing. In some embodiments, the heat transfer design interface 302 advises a user on the cost of each option (e.g., spaced or non-spaced). The cost may be provided as one or both of a per item cost or a total order cost where, for example, a user is ordering more than one article.

In some embodiments, a touch screen interface is provided, which may allow a user to input symbols and/or images as desired. For example, the touch screen interface may allow the user to input a specific name and/or number (e.g., for sports apparel) or identify other heat transfers to be added (such as images or symbols). In some embodiments, certain letter and/or number combinations may be preloaded (or combinations of other heat transfers may be reloaded as may be desired). Based on the user's inputs, the bonder may be configured to automatically pick one or more numbers and/or names that the user has selected, and may be able to place them in a pre-set template such that the names, numbers, or any other heat transfers to be added are aligned in a pre-set template. This may then allow the names and numbers to be aligned on the garment. In some embodiments, a vision system projects an image or electronic template onto the garment to ensure proper alignment and positioning of the individual heat transfer items. This heat transfer may then be prepared and provided to a bonder, such as an automatic bonder. The bonder may then be configured to initiate a bonding process to bond the template to the garment via heat press.

In some embodiments, a voice-activated interface is provided, which may allow a user to input symbols and/or images as desired. For example, the voice-activated interface may allow the user to input a specific name and/or and number (e.g., for sports apparel) or identify other heat transfers to be added (such as images or symbols) by voice command. In some embodiments, certain letter and/or number combinations may be preloaded (or combinations of other heat transfers may be reloaded as may be desired). Based on the user's inputs, the heat transfer design interface may be configured to automatically pick one or more numbers and/or names that the user has selected, and may be able to place them in a pre-set template such that the names, numbers, or any other heat transfers to be added are aligned in a pre-set template. This may then allow the names and numbers to be aligned on the garment.

According to some embodiments, a digital workflow interface component may be included and may function from the time that an order is received to the time that an order is shipped. In some embodiments, the digital workflow may, but need not include any of the following: providing an ordering interface; receiving one or more article selections from a customer; receiving one or more heat transfer selections from a customer; finalizing an order; accepting payment information; uploading the order to a production database; communicating information to an external supplier, if necessary; arranging delivery from an external supplier, if necessary; adding tracking information to and tracking delivered items, if necessary and if desired; allocating production; performing a production process, such as production and application of the heat transfer along with placement of the platens and any other specified production; performing quality control; performing item allocation; and packing and shipping the item.

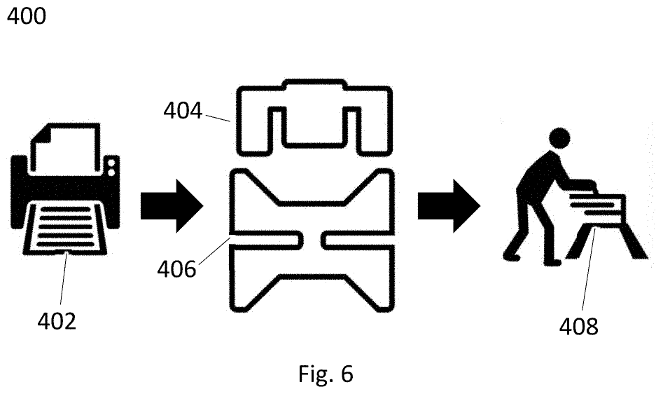

Turning now to exemplary FIG. 6, a pictorial diagram 400 of an exemplary embodiment of a system and process for preparing and bonding a heat transfer is shown. According to an exemplary embodiment, a heat transfer may first be printed using a printer 402. Next, one or more platens 404, 406 may be automatically (or manually) selected. Finally, the heat transfer and an article may be added to a bonder or heat press 408, which operates to apply the heat transfer to the article as an embellishment.

According to some embodiments, a bonder component is provided to integrate the bonder into the workflow using robotics and various automated technology components. The automated technology components/bonder may further comprise an element for notifying an operator upon completion of the bonding process. In some embodiments, the element for notifying an operator may be an LED (or any other visual device) that illuminates upon completion, an audio device that creates a sound upon completion, or a combination of both a visual and audio device. According to some embodiments, a bonder may be highly automated and may offer numerous advantages, such as streamlined transfer positioning, quick platen change (optionally with platens designed to be positioned inside garments rather than being positioned so that both sides of the garment are disposed atop the platen, this platen design being known as a “threaded” platen), and a full range of other bonder capabilities. In other exemplary embodiments, a partially manually controlled or fully manually controlled bonder may be used instead.

In some embodiments, the system may include a vision system, which may include a variety of different components. For example, components of the vision system may include, but are not limited to, one or more camera units, one or more lights, one or more lasers, a projection system to auto-generate the customized garment face/embellishment, or any combination of the aforementioned components.

In some embodiments, a vision system projects an image or electronic template onto the garment to ensure proper alignment and positioning of the individual heat transfer items. An operator may then approve or reject the image or electronic template suggested. In some embodiments, the operator may approve or reject the image or electronic template via voice command. If the heat transfer is approved, the system may then prepare the heat transfer and provide it to a bonder, such as an automatic bonder as discussed herein. The bonder may then initiate a bonding process to bond the template to the garment via heat press. However, the bonding process may be paused or stopped at an operator's discretion via a ‘stop’ control. In some embodiments, the control may be a physical button, a virtual button, a button on a touch-screen interface, or voice-command-activated. Voice command elements described herein may be used in combination with the touch screen interface and other embodiments disclosed in the present application.

In one embodiment, the vision system may be comprised of at least one laser. The laser may project an image of the heat transfer to be bonded, thereby presenting the user with an accurate representation of where on the garment or article the heat transfer will be positioned. In some embodiments, the vision system is adjustable in one or more directions within an x, y, and z plane. The vision system may comprise an extendable mechanical arm, having a laser disposed towards an edge of the mechanical arm. The laser may project an image of the heat transfer to be bonded down onto a surface of the article or garment. However, the image of the heat transfer to be bonded may be projected in any direction. For example, a user may want to visualize the heat transfer to be bonded on a wall; a user may then rotate (or position) the laser to no longer project onto the wall, but rather to in a direction perpendicular to the wall (e.g., downward onto the article or garment). Furthermore, the vision system may be positioned on a swivel where it may rotate around an axis point or pivot about a fulcrum. Additionally, the vision system may comprise a laser projector having one laser light source for single-color projection or multiple sources for full-color projection (e.g., red, green, and blue). The brightness of the laser may also be adjusted. The vision system may also project a grid for enhanced garment/article alignment on a base where the laser projects the image of the heat transfer to be bonded.

In some embodiments, the vision system may also comprise an adjustable base where the garment or article may be placed. The adjustable base may move along one or more of the x, y, and z plane. The adjustable base may automatically adjust to an optimal position for printing, where attributes of optimal printing may be determined by a user. For example, optimal positioning may be determined by adjusting the base so that the laser's projection of the image of the heat transfer to be printed is in the center of base.

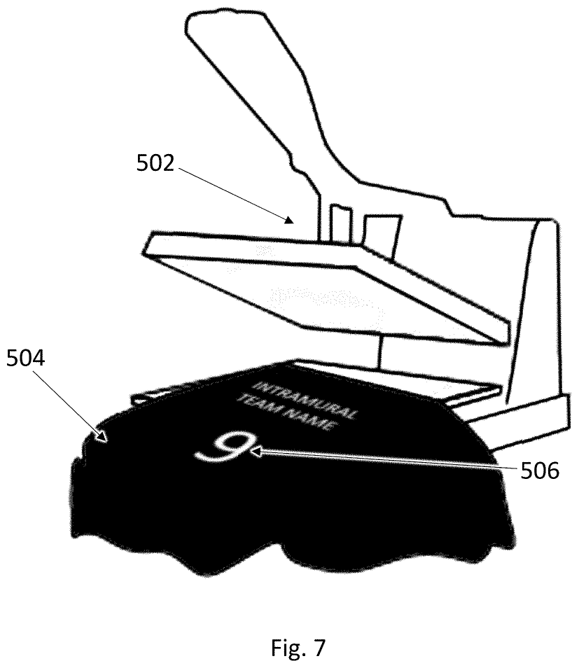

Turning now to exemplary FIG. 7, an exemplary embodiment of a completed heat transfer is shown. After the heat press 502 has been operated, a completed garment 504 (or other completed article) will have the heat transfer embellishment 506 applied thereupon. The garment 504 may then be removed from the heat press 502 and worn.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art (for example, features associated with certain configurations of the invention may instead be associated with any other configurations of the invention, as desired).

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A heat transfer bonding system comprising:
an interface component;
a digital workflow having an ordering interface;
a bonder configured to initiate a bonding process; and
a vision system.

2. The system of claim 1, where the interface component is a touch screen.

3. The system of claim 1, where one or more letter and/or number combinations are preloaded on the interface component.

4. The system of claim 1, where the bonder is automated.

5. The system of claim 1, where the interface component is configured to allow a user upload a heat transfer pattern.

6. The system of claim 5, where the interface component is configured to interpret the heat transfer pattern and map the heat transfer pattern to an interface heat transfer pattern specific to an article.

7. The system of claim 1, where the interface component is configured to allow a user to input information on a specific article in order to upload article identity information to the ordering interface.

8. The system of claim 7, where the interface component is configured to allow a user to scan a label on the specific article in order to upload the article identity information.

9. The system of claim 1, further comprising a self-service kiosk.

10. A method for ordering a customized article comprising:
accessing an interface;
selecting an article;
selecting one or more heat transfer items;
arranging the one or more heat transfer items on the article; and
finalizing an order.

11. The method of claim 10, further comprising uploading a heat transfer pattern into the interface.

12. The method of claim 11, further comprising:
interpreting, by the interface, the heat transfer pattern; and
mapping, by the interface, the heat transfer pattern to an interface heat transfer pattern specific to the article.

13. The method of claim 10, further comprising scanning an RFID tag of an article at an RFID scanner at a self-service kiosk.

14. The method of claim 13, further comprising:
determining, by the self-service kiosk, whether the article is one that exists in a database associated with the interface; and
if the garment is not in the database associated with the interface, retrieving, by the self-serve kiosk, information about the garment.

15. The method of claim 14, where information about the garment comprises attribute information stored in the RFID tag or attribute information available from an online database.

16. The method of claim 10, where the interface is a web interface.

17. The method of claim 10, where the interface is a mobile device application.

18. A method for preparing a customized article comprising:
receiving an order in a production database for an article to be customized with a heat transfer;
preparing at least one heat transfer sheet based on the order received in the production database;
selecting one or more platens to support the article;
bonding, via an automated bonder, the at least one heat transfer sheet to the article.

19. The method of claim 18, further comprising projecting an image of the heat transfer onto the article before bonding the step of bonding.

20. The method of claim 18, further comprising shipping the customized article to a customer.
